(19) United States
(12) Patent Application Publication
(10) Pub. No.: US 2007/0287792 A1
(43) Pub. Date: Dec. 13, 2007

(54) Dental materials based on ring-opening polymerizable acid monomers

(75) Inventors: Norbert Moszner, Triesen (LI); Jorg Angermann, Sargans (CH); Frank Zeuner, Schellenberg (LI); Armin de Mejere, Gottingen (DE); Urs Karl Fischer, Arbon (CH); Volker Rheinberger, Vaduz (LI)

Correspondence Address: BUCHANAN, INGERSOLL & ROONEY PC, POST OFFICE BOX 1404, ALEXANDRIA, VA, 22313-1404, US

(73) Assignee: IVOCLAR VIVADENT AG, Schaan (LI)

(21) Appl. No.: 11/585,280

(22) Filed: Oct. 24, 2006

(30) Foreign Application Priority Data
Jun. 7, 2006 (EP) 06115108.0

(51) Int. Cl. C08L 31/00

(52) U.S. Cl. 524/556

(57) ABSTRACT

Dental material which contains at least one radically polymerizable monomer according to the general formula (I):

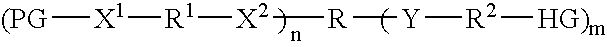

in which PG is a cyclic, ring-opening polymerizable group; X¹ is absent, O, S, is an ester, amide or urethane group; X² is absent with, O, S, is an ester, amide or urethane group; Y is absent, O, S, is an ester, amide or urethane group; R is an organic radical with a valency of (n+m), with 1 to 35 carbon atoms and 0 to 8 heteroatoms, the H atoms of which can be wholly or partially substituted by F atoms; R¹ is absent or is a C₁-C₁₆ alkylene radical which can be interrupted by O atoms; R² is absent or is a C₁-C₁₆ alkylene radical which can be interrupted by O atoms; n is 1, 2, 3, 4, 5 or 6; m is 1, 2 or 3; HG is —P═O(OH)₂; —P═O(OH)(OR¹⁴); —O—P═O(OH)₂, —O—P═O(OH)(OR¹⁵) or —SO₂OH, wherein R¹⁴ is a C₁-C₁₅ alkyl radical, phenyl or benzyl radical; and R¹⁵ is a C₁-C₁₅ alkyl radical, phenyl or benzyl radical.

This application claims priority, pursuant to 35 U.S.C. §119, to European Patent Application No. 06115108.0 filed Jun. 7, 2006, the entire contents of which is incorporated hereby by reference.

### FIELD

The invention relates to dental materials based on ring-opening polymerizable, acid monomers. The dental materials are particularly suitable for preparing composites, cements, adhesives or coatings.

### BACKGROUND

In the discussion that follows, reference is made to certain structures and/or methods. However, the following references should not be construed as an admission that these structures and/or methods constitute prior art. Applicant expressly reserves the right to demonstrate that such structures and/or methods do not qualify as prior art.

Compared with linear monomers, radically polymerizable cyclic monomers are characterized by a clearly smaller polymerization shrinkage (cf. R. K. Sadhir, R. M. Luck, Expanding Monomers, CRC Press, Boca Raton etc. 1992). In the case of dental materials polymerization shrinkage can lead, inter alia, to disadvantageous shrinkage stresses and edge-gap formation in the case of filling composites, to reduced substrate adhesion in the case of fixing composites and coating materials and to impairment of the dimensional stability of prosthetic plastics. Accordingly, low-shrinkage monomers have aroused great interest in the dental field (cf. N. Moszner, U. Salz, Progress Polymer Sci. 26 (2001) 535-576).

In order to improve the adhesion of dental filling composites to the tooth hard substance, these are used in combination with enamel-dentine adhesion promoters. So-called “self-etching” enamel-dentine adhesives are increasingly used, thereby dispensing with a pre-treatment acid etching technique, e.g., etching the tooth hard substance with phosphoric acid (N. Moszner, U. Salz, J. Zimmermann, Dental Mater. 21 (2005) 895-910). Such adhesives are based on adhesive monomers which, in addition to a radically polymerizable group, usually contain a (meth)acrylate group, a strongly acidic adhesive group, e.g., phosphonic acid or dihydrogenphosphate groups. Recently, composites which exhibit self-adhesive properties and are thus particularly suitable as fixing cement have also been prepared on the basis of these monomers. A disadvantage of these monomers is that they are not compatible with other monomers. For example, known radically ring-opening cyclic monomers, such as spiroorthoesters, spiroorthocarbonates or cyclic ketene acetals are not storage-stable in the presence of strong acids and therefore cannot be used together with these. Likewise, homogeneous mixtures storage-stable at room temperature cannot be prepared on the basis of typical cationically ring-opening cyclic monomers, such as glycidyl ethers, cycloaliphatic epoxides or oxetanes or other cyclic ethers, in combination with the abovementioned strongly acidic monomers.

### SUMMARY

One aspect of the invention is to provide dental materials which have both self-adhesive properties and a low polymerization shrinkage in combination with good mechanical properties and high reactivity.

This can be achieved by dental materials which may contain at least one radically polymerizable monomer according to the general formula (I):

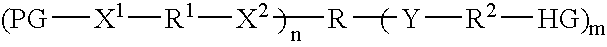

in which
PG=a cyclic, ring-opening polymerizable group;
X¹=is absent, O, S, an ester, amide or urethane group;
X²=is absent, O, S, an ester, amide or urethane group;
Y=is absent, O, S, an ester, amide or urethane group;
R=an organic radical with a valency of (n+m), with 1 to 35 carbon atoms and 0 to 8 heteroatoms, the H atoms of which can be wholly or partially substituted by F atoms;
R¹=is absent or a C₁-C₁₆ alkylene radical which can be interrupted by O atoms;
R²=is absent or a C₁-C₁₆ alkylene radical which can be interrupted by O atoms;
n=1, 2, 3, 4, 5 or 6;
m=1, 2 or 3;
HG=—P═O(OH)₂; —P═O(OH)(OR¹⁴); —O—P═O(OH)₂, —O—P═O(OH)(OR¹⁵) or —SO₂OH with R¹⁴=a C₁-C₁₅ alkyl radical, phenyl or benzyl radical, R¹⁵=a C₁-C₁₅ alkyl radical, phenyl or benzyl radical.

### DETAILED DESCRIPTION

Compounds of certain embodiments of the present invention contain, in addition to a ring-opening polymerizable group PG, an acid group HG. Formula (I) and the other formulae shown herein cover all the constitutional and stereoisomeric forms as well as mixtures of different constitutional and stereoisomeric forms, such as racemates. The formulae cover only compounds which are consistent with the chemical valency theory.

The indication that a radical can be interrupted, e.g. by O, means that these atoms or groups are inserted into the carbon chain of the radical, i.e. they are bounded by carbon atoms on both sides. The number of these foreign atoms or groups is therefore at least 1 smaller than the number of carbon atoms, and the foreign atoms or groups cannot be terminal. According to certain embodiments of the invention, in cases in which heteroatoms can contain radicals, radicals without heteroatoms are preferred.

R can be an alicyclic, aliphatic or aromatic radical or a combination thereof. Combinations include, for example, alkylene-arylene, alkylene-arylene-alkylene and arylene-alkylene-arylene groups, in particular —CH₂—Ph— and —CH₂—Ph—CH₂— groups. The heteroatoms optionally present in R are preferably O and/or N. The hydrogen atoms of R can be wholly or preferably partially substituted by F atoms. Radicals without fluorine substituents are preferred.

Preferred ring-opening polymerizable groups PG are:

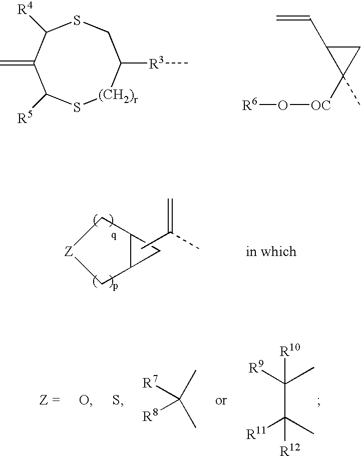

R³=is absent with or a C₁-C₁₆ alkylene radical which can be interrupted by O atoms;
R⁴=H or a C₁₀ alkyl radical;
R⁵=H or a C₁-C₁₀ alkyl radical;
R⁶=H, a C₁-C₁₀ alkyl radical, phenyl radical or benzyl radical;
R⁷=H, CN, CO—R¹³, —CO—R¹³ or R¹³;
R⁸=H, CN, CO—OR³, —CO—R³, or R¹³;
R⁹-R¹²=independently of each other H, —CO—OR³, —CONHR¹³, —CO—R¹³, a C₁-C₁₅ alkyl radical which can be interrupted by O, a cycloaliphatic C₄-C₁₂ radical, a bicyclic C₅-C₁₂ radical, a C₆-C₁₄ aryl radical or C₇-C₂₀ alkyl aryl radical;
R¹³=a C₁-C₁₅ alkyl radical which can be interrupted by O, a cycloaliphatic C₄-C₁₂ radical, a bicyclic C₅-C₁₂ radical, a C₆-C₁₄ aryl radical or C₇-C₂₀ alkyl aryl radical, wherein a plurality of R¹³ radicals can be present and they can be the same or different;
q=0, 1, 2 or 3;
p=0, 1 or 3;
r=0 or 1.

According to certain embodiments, ring-opening polymerizable monomers in which the variables of the polymerizable groups indicated above have the following meaning are particularly preferred, wherein these meanings can be chosen independently of each other:
R³=is absent or a C₁-C₁₀ alkylene radical which can be interrupted by O atoms, in particular —(CH₂)₁₀—, —CH₂—CH₂— or —CH₂CH₂—O—CH₂CH₂—;
R⁴=H or a C₁-C₅ alkyl radical;
R⁵=H or a C₁-C₅ alkyl radical;
R⁶=C₁-C₅ alkyl radical, a phenyl radical or benzyl radical; in particular a C₁-C₃ alkyl radical or phenyl radical;
R⁷=H, CO—OR¹³, —CO—R¹³ or R¹³;
R⁸=H, CO—OR¹³, —CO—R³, or R¹³;
R⁹-R¹²=independently of each other respectively H, —CO—OR¹³, —CO—R¹³, a C₁-C₁₅ alkyl radical which can be interrupted by O, a cycloaliphatic C₄-C₆ radical, a bicyclic C₅-C₁₂ radical, a phenyl radical, or benzyl radical, in particular H, —CO—OC₂H₅, —CO-phenyl, C₁-C₅ alkyl, a bicyclic C₅-C₁₀ radical or a benzyl radical;
R¹³=a C₁-C₁₀ alkyl radical which can be interrupted by O, a cycloaliphatic C₄-C₆ radical, a phenyl or benzyl radical, in particular methyl, ethyl, propyl, phenyl and benzyl, wherein a plurality of R¹³ radicals can be present and can be the same or different;
q=0, 1 or 2;
p=0, 1, 2 or 3;
r=0 or 1.

According to alternative embodiments monomers in which PG is a group according to one of the following formulae are quite particularly preferred:

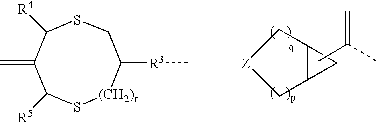

Definitions of the other variables of Formula (I) which can be chosen independently of each other are:
X¹=is absent, O, an ester, amide or urethane group, in particular an ester, amide or urethane group;
X²=is absent, O, an ester, amide or urethane group, in particular an ester, amide or urethane group;
Y=is absent, O, an ester, amide or urethane group, in particular an ester, amide or urethane group;
R=a cyclic or aliphatic organic radical with a valency of (n+m) with 1 to 20 carbon atoms and 0 to 8, preferably 0 to 4 heteroatoms, the H atoms of which can be wholly or partially substituted by F atoms;
R¹=is absent or a C₁-C₁₂ alkylene radical which can be interrupted by O atoms;
R²=is absent or a C₁-C₁₂ alkylene radical which can be interrupted by O atoms;
n=1, 2 or 3;
m=1, 2 or 3;
HG=—P═O(OH)₂; —O—P═O(OH)₂ or —SO₂OH.

According to other embodiments, monomers in which at least one of the variables has one of the following preferred variables are particularly preferred:
X¹=is absent or an ester group;
X²=is absent;
Y=is absent;
R=an aliphatic, preferably linear organic radical with 2 to 12 carbon atoms, the H atoms of which can be wholly or partially substituted by F atoms, or phenylene;
R¹=is absent;
R²=is absent, methylene or ethylene;
n=1 or 2;
m=1;
HG=—P═O(OH)₂; —O—P═O(OH)₂ or —SO₂OH.

The monomers of the general formula (I) can be obtained starting from suitably functionalized cyclic monomers by reaction with corresponding acid group-containing compounds.

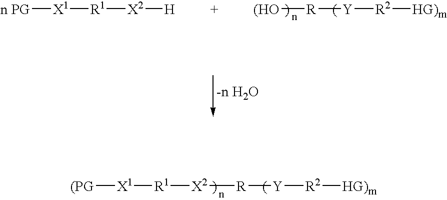

According to one specific example, (n, m=1, X¹, Y, R¹ and R² are absent, PG=3-methylene X²═C—CO, HG ═O—PO(OH)₂):

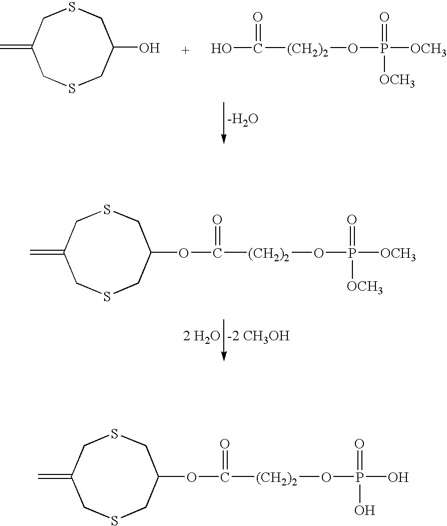

In the reaction, aspects of the protective group technique are to be taken into account, i.e. firstly the phosphoric, phosphonic or sulphonic acid ester is coupled with the suitably functionalized cyclic monomers and then the acid group is released.

Suitably functionalized cyclic monomers for the synthesis of monomers of the general formula I are known from the literature. For example the synthesis of vinyl cyclopropanene and of bicyclic cyclopropyl acrylates is described by N. Moszner et al., Macromol. Rapid. Commun. 18 (1997) 775-780, and A. de Meijere et al., Eur. J. Org. Chem, 2004, 3669-3678. The synthesis of functionalized cyclic allyl sulphides has been published by R. A. Evans and E. Rizzardo in J. Polym. Sci., Part A. Polym. Chem. 39 (2001) 202-215; Macromolecules 33 (2000) 6722-6731.

Exemplary embodiments of the ring-opening polymerizable acid monomers of the general formula I are:

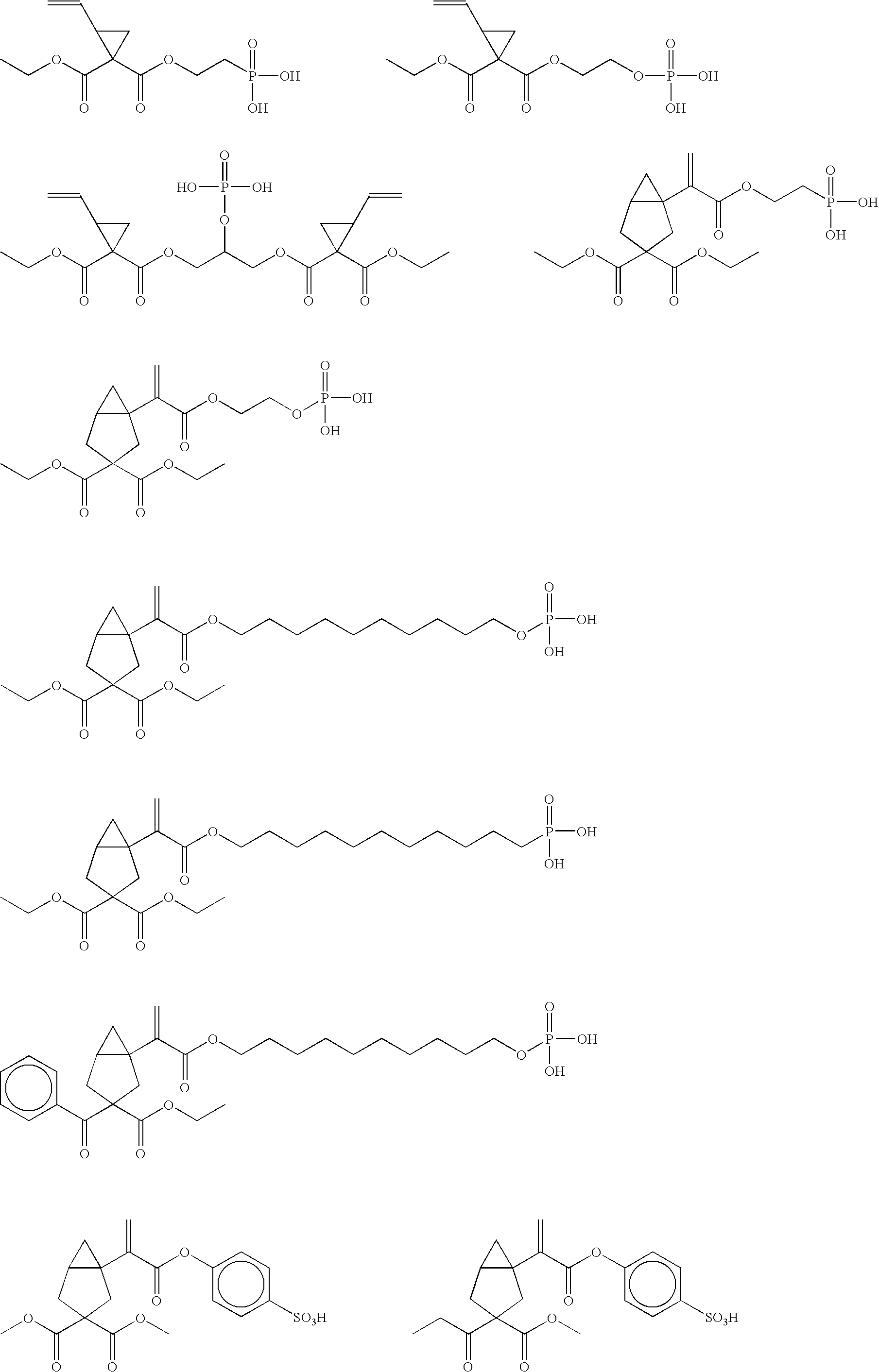

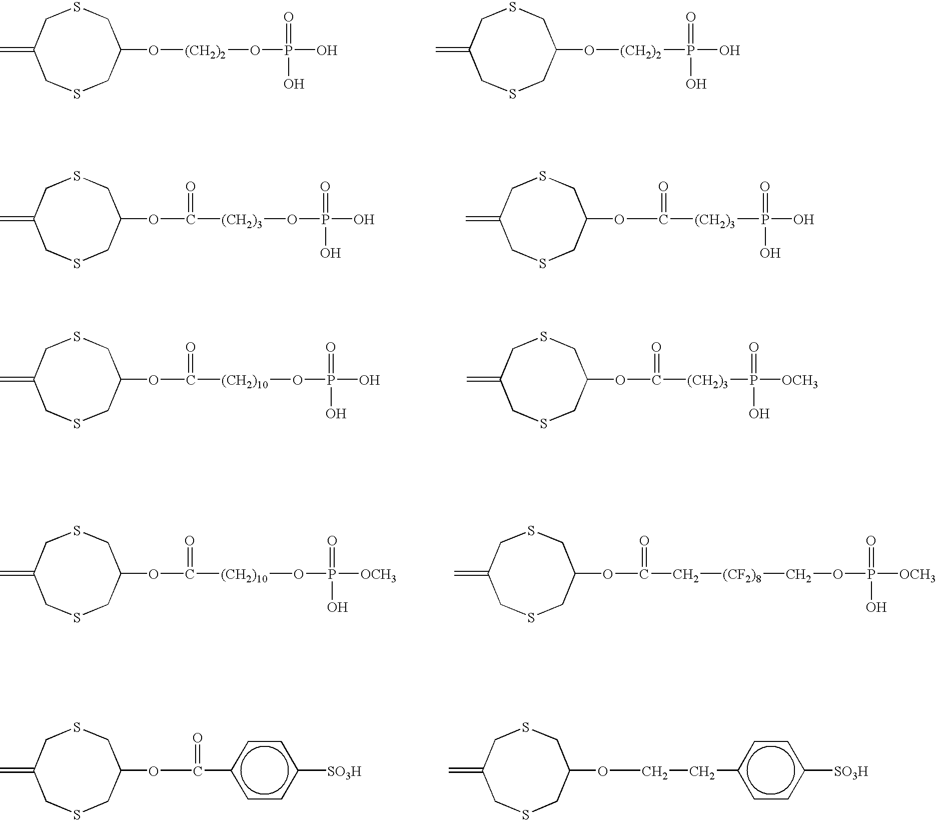

Dental materials according to the invention based on the monomers of Formula (I) can be polymerized with the known radical initiators, as described, for example, in Encyclopedia of Polymer Science and Engineering, Vol. 13, Wiley-Intersci. Pub., New York etc. 1988, 754ff. Photoinitiators, such as those known from J. P. Fouassier, J. F. Rabek (publ.), Radiation Curing in Polymer Science and Technology, Vol. II, Elsevier Applied Science, London and New York 1993, are particularly suitable. For the UV or visible range, benzoin ether, dialkylbenzilketals, dialkoxyacetophenones, acyl or bis-acyl phosphine oxides, α-diketones such as 9,10-phenanthrenequinone, diacetyl, furil, anisil, 4,4′-dichlorobenzil and 4,4′-dialkoxybenzil and camphorquinone are preferred as photoinitiators.

Furthermore, azo compounds, such as 2,2′-azobis(isobutyronitrile) (AIBN) or azobis-(4-cyanovalerianic acid), or peroxides, such as dibenzoyl peroxide, dilauroyl peroxide, tert.-butyl peroctoate, tert.-butyl perbenzoate or di-(tert.-butyl)-peroxide can also be used as initiators for radical polymerization. Benzopinacol and 2,2′-dialkyl benzopinacols are particularly suitable as initiators for hot-curing.

To accelerate the initiation, peroxides and α-diketones can be used in combinations with aromatic amines. Preferred redox systems include combinations of benzoyl peroxide or camphorquinone with amines, such as N,N-dimethyl-p-toluidine, N,N-dihydroxyethyl-p-toluidine, p-dimethyl-aminobenzoic acid ethyl ester or structurally related systems. In addition, redox systems which contain peroxides in combination with ascorbic acid, barbiturates or sulphinic acids as reduction agents are also suitable.

Dental materials according to the invention can also contain one or more monomers of Formula (I). In addition to the monomers of Formula (I) they can contain further radically polymerizable monomers with one or more radically polymerizable groups. According to certain embodiments, dental materials which contain at least one further radically polymerizable monomer with 2 or more, preferably 2 to 3 radically polymerizable groups, are particularly preferred. Multi-functional monomers have cross-linking properties.

Preferred additional monomers are mono- or multi-functional (meth)acrylates or (meth)acrylamides ((meth)acryl compounds). Monofunctional (meth)acryl compounds include compounds with one, and by multi-functional (meth)acryl compounds include compounds with two or more, preferably 2 to 3 (meth)acryl groups.

Multi-functional monomers according to the present invention include bisphenol-A-di(meth)acrylate, bis-GMA (an addition product of methacrylic acid and bisphenol-A-diglycidyl ether), ethoxylated bisphenol-A-di(meth)acrylate, UDMA (an addition product of 2-hydroxyethyl methacrylate and 2,2,4-trimethyl hexamethylene diisocyanate), di-, tri- or tetraethylene glycol di(meth)acrylate, trimethylolpropane tri(meth)acrylate, pentaerythritol tetra(meth)acrylate, as well as butanediol di(meth)acrylate, 1,10-decanediol di(meth)acrylate or 1,12-dodecanediol di(meth)acrylate.

Dental materials according to alternative embodiments of the invention contain, in addition to the monomer of Formula (I), preferably at least one further radically polymerizable, acid group-containing monomer. These acid group-containing monomers are also called acid monomers in the following. Preferred acid groups can include carboxylic acid groups, phosphonic acid groups, phosphate groups and/or sulphonic acid groups, these groups being able to be present in the acid form or in the form of an ester. Monomers with phosphonic acid groups or phosphate groups may be particularly preferred. The monomers can have one or more acid groups; compounds with 1 to 2 acid groups may be preferred.

Preferred polymerizable carboxylic acids according to certain embodiments are maleic acid, acrylic acid, methacrylic acid, 2-(hydroxymethyl)acrylic acid, 4-(meth)acryloyl oxyethyl trimellitic acid and the corresponding anhydride, 10-methacryloyl oxydecyl malonic acid, N-(2-hydroxy-3-methacryloyloxypropyl)-N-phenylglycine and 4-vinyl benzoic acid.

Preferred phosphonic acid monomers according to certain embodiments are vinyl phosphonic acid, 4-vinyl phenyl phosphonic acid, 4-vinyl benzyl phosphonic acid, 2-methacryloyl oxyethyl phosphonic acid, 2-methacryl amidoethyl phosphonic acid, 4-methacrylamido-4-methyl-pentyl-phosphonic acid, 2-[4-(Dihydroxyphosphoryl)-2-oxa-butyl]-acrylic acid and 2-[2-Dihydroxyphosphoryl)-ethoxymethyl]-acrylic acid-2,4,6-trimethyl-phenylester.

Preferred acid polymerizable phosphoric acid esters according to certain embodiments are 2-methacryloyl oxypropyl mono- and dihydrogen phosphate, 2-methacryloyl oxyethyl mono- and dihydrogen phosphate, 2-methacryloyl oxyethyl-phenyl-hydrogen phosphate, dipentaerythritol-pentamethacryloyloxyphosphate, 10-methacryloyloxydecyl-dihydrogen phosphate, dipentaerythritol pentamethacryloyloxy phosphate, phosphoric acid mono-(1-acryloyl-piperidin-4-yl)-ester, 6-(methacrylamido)hexyl dihydrogen phosphate and 1,3-bis-(N-acryloyl-N-propyl-amino)-propan-2-yl-dihydrogen phosphate.

Preferred polymerizable sulphonic acids according to certain embodiments are vinyl sulphonic acid, 4-vinyl phenyl sulphonic acid or 3-(methacrylamido)propyl sulphonic acid.

According to certain embodiments quite particularly preferred are mixtures of acid monomers of Formula (I) with known low-shrinkage radically ring-opening polymerizable monomers such as mono- or multifunctional vinyl cyclopropanes or bicyclic cyclopropane derivates, preferably the monomers disclosed in DE 196 16 183 C2 and EP 1 413 569, or cyclic allyl sulphides, preferably the monomers disclosed in U.S. Pat. No. 6,043,361 and U.S. Pat. No. 6,344,556. Further preferred are also mixtures of acid monomers of Formula (I) with at least one further ring-opening polymerizable monomer and at least one radically polymerizable monomer with two or more radically polymerizable groups, in particular the multi-functional (meth)acrylate compounds listed above.

According to certain embodiments particularly preferred ring-opening polymerizable monomers are vinyl cyclopropanes, such as 1,1-di(ethoxycarbonyl- or 1,1-di(methoxycarbonyl)-2-vinyl cyclopropane or the esters of 1-ethoxycarbonyl- or 1-methoxycarbonyl-2-vinyl cyclopropane-carboxylic acid with ethylene glycol, 1,1,1-trimethylolpropane, 1,4-cyclohexanediol or resorcinol. Preferred bicyclic cyclopropane derivates are 2-(bicyclo[3.1.0]hex-1-yl)acrylic acid methyl or ethyl ester or their disubstitution products in 3-position such as (3,3-bis(ethoxycarbonyl) bicyclo[3.1.0]hex-1-yl)acrylic acid methyl or ethyl ester. Preferred cyclic allyl sulphides are above all the addition products of 2-(hydroxymethyl)-6-methylene-1,4-dithiepan or 7-hydroxy-3-methylene-1,5-dithiacylooctane with 2,2,4-trimethyl hexymethylene-1,6-disisocyanate or the asymmetrical hexamethylene diisocyanate-trimer Desmodur VP LS 2294 from Bayer AG.

Furthermore the dental materials according to the invention can contain one or more fillers, preferably organic or inorganic particulate fillers. According to certain alternative embodiments, preferred inorganic particulate fillers are amorphous spherical nanoparticulate fillers based on oxides, such as pyrogenic silicic acid or precipitation silicic acid, ZrO₂ and TiO₂ or mixed oxides of SiO₂, ZrO₂ and/or TiO₂ with an average particle diameter of 10 to 200 nm, mini-fillers, such as quartz, glass ceramic or glass powder with an average particle size of 0,2 to 5 μm and X-ray-opaque fillers, such as ytterbium trifluoride or nanoparticulate tantalum(V)-oxide or barium sulphate. In addition fibrous fillers such as glass fibers, polyamide or carbon fibers can also be used.

Finally, further additives such as, e.g., stabilizers, UV-absorbers, dyes or pigments as well as solvents or lubricants can, if required, be added to the dental materials according to the invention based on monomers of Formula (I).

Dental materials according to certain embodiments the invention preferably contain:
(a) 0.5 to 30 wt.-% acid ring-opening polymerizable monomer according to Formula (I),
(b) 0.01 to 5 wt.-% initiator,
(c) 5 to 90 wt.-% further radically polymerizable monomer, preferably 5 to 90 wt.-% further ring-opening polymerizable monomer and 0 to 50 wt.-% multi-functional (meth)acrylate,
(d) 0 to 85 wt.-% filler,
(e) optionally 0.01 to 5 wt.-% additive and
(f) 0 to 50 wt.-% solvent.

All percentages, unless otherwise indicated, relate to the total mass of the dental material.

Dental materials according to the invention can comprise dental products and particularly suitable as composite, cement, adhesive or coating material.

Dental materials for use as adhesive can contain:
(a) 1 to 30 wt.-% acid ring-opening polymerizable monomer according to Formula (I),
(b) 0.1 to 2 wt.-% initiator,
(c) 5 to 80 wt.-% further radically polymerizable monomer, preferably 5 to 80 wt.-% further ring-opening polymerizable monomer and 0 to 30 wt.-% multi-functional (meth)acrylate,
(d) 0 to 20 wt.-% filler,
(e) optionally 0.01 to 50 wt.-% additive and
(f) 0 to 50 wt.-% solvent.

Dental materials for use as cements can contain:
(a) 1 to 30 wt.-% acid ring-opening polymerizable Monomer according to Formula (I),
(b) 0.1 to 2 wt.-% initiator,
(c) 5 to 30 wt.-% further radically polymerizable monomer, preferably 5 to 30 wt.-% further ring-opening polymerizable monomer and 0 to 10 wt.-% multi-functional (meth)acrylate,
(d) 0 to 70 wt.-% filler and
(e) optionally 0.01 to 5 wt.-% additive.

Dental materials for use as composite can contain:
(a) 1 to 20 wt.-% acid ring-opening polymerizable monomer according to Formula (I),
(b) 0.1 to 2 wt.-% initiator,
(c) 5 to 20 wt.-% further radically polymerizable monomer, preferably 5 to 20 wt.-% further ring-opening polymerizable monomer and 0 to 10 wt.-% multi-functional (meth)acrylate,
(d) 0 to 85 wt.-% filler and
(e) optionally 0.01 to 2 wt.-% additive.

The present invention also relates to the use of radically polymerizable monomers of Formula (I) for the preparation of dental materials, preferably the dental materials described above.

The invention also relates to a process for the preparation of shaped bodies, such as crowns, bridges, inlays and artificial teeth, in which a dental material according to the invention is shaped in a manner known per se to produce the shaped body and then at least partially, preferably completely, cured. The curing preferably takes place by radical polymerization.

The invention is described in further detail below with reference to examples.

### EMBODIMENT EXAMPLES

### Example 1

### Synthesis of a Ring-Opening Polymerizable Dihydrogen Phosphate

### Stage 1: Carbonic acid-O-[5,5-bis(ethoxycarbonyl)oct-7-en-2-inyl]-O′-methylester (1)

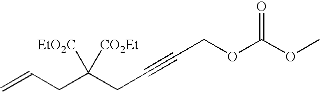

Allyl malonic acid diethyl ester (9.01 g, 45 mmol) was added to a stirred suspension of sodium hydride (1.9 g 60% dispersion in mineral oil, 47.5 mmol) in anhydrous DMF (45 ml). The reaction mixture was then cooled to 10° C. and carbonic acid-O-(4-chlorobut-2-inyl)-O′-methylester (7.4 g, 46 mmol), prepared according to A. Steinig, A. de Meijere, (Eur. J. Org. Chem. 1999, 1333-1344) added dropwise within 30 minutes. The mixture was stirred for 24 hours at room temperature and the solvent distilled off under vacuum (T_{bath}<60° C., 0.1 mbar). The residue was dissolved in 200 ml ether, washed with 50 ml 5% sulphuric acid, 50 ml of water and 50 ml of saturated NaCl solution and then dried over magnesium sulphate. The solvent was again distilled off under vacuum and the crude product (14.3 g) chromatographically purified (100 ml flash silica gel with pentane/ether 10:1 to 5:1). Yield: 8.1 g (55%) colorless to pale-yellow oil.

¹H-NMR (250 MHz, CDCl₃): δ=1.23 (t, 6H, 2 CH₃), 2.76 (ddd, 2H, 6-H), 2.82 (t, 2H, 4-H), 3.79 (s, 3H, CH₃), 4.19 (q, 4H, 2 CH₂), 4.67 (t, 2H, 1-H), 5.10 (ddd, 1H, 8-Hₜᵣₐₙₛ), 5.15 (ddd, 1H, 8-H_{cis}), 5.60 (ddd, 1H, 7-H).

### Stage 2: 2-[3,3-bis(ethoxycarbonyl)bicyclo[3.1.0]hex-1-yl}acrylic acid (2)

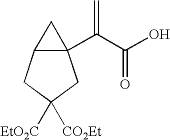

Pd(OAc)₂ (337 mg, 1.50 mmol) was added to a solution of tris(2-furyl)phosphine (766 mg, 3.30 mmol), tetramethyl ammonium bromide (254 mg, 1.65 mmol), BHT (397 mg, 1.80 mmol) and (1) (=Stage 1, 16.3 g, 50 mmol) in degassed 60% aqueous acetic acid (1000 ml) under argon and the mixture stirred at 25° C. for 1 hour. Then the reaction atmosphere was completely replaced by carbon monoxide and stirred vigorously at room temperature until the carbonic acid ester (1) was completely converted (˜24 hours, TLC check). After distillation-off of the solvent under vacuum (40° C./0.5 mbar) the residue was suspended in 200 ml of diethyl ether and filtered off over celite. The product was then extracted with 0.5 M aqueous soda solution (250 ml) and the aqueous extract washed twice with 50 ml of diethyl ether in each case, and after addition of 10 mg of BHT the aqueous phase was set with 12 N HCl (approximately 4-5 ml) to a pH of approximately 1.0. The organic phase was separated off and the aqueous layer saturated with NaCl and extracted 3 times with 50 ml of diethyl ether in each case. The combined organic phases were then washed with 100 ml saturated NaCl solution and dried over anhydrous sodium sulphate. After distillation-off of the solvent, 10.8 g (73% yield) of a slightly yellow viscous oil was obtained which could be used for the next stage without purification.

¹H-NMR (300 MHz, CDCl₃): δ=0.54 (dd, 1H, 6-H_{endo}), 0.75 (ddd, 1H, 6-Hₑₓₒ), 1.21 (t, 3H, CH₃), 1.25 (t, 3H, CH₃), 1.60 (dddd, 1H), 2.57 (dd, 1H), 2.58 (dd, 1H), 2.62 (ddd, 1H), 2.74 (d, 1H), 4.14 (q, 2H, OCH₂), 4.19 (q, 2H, OCH₂), 5.73 (d, 1H, 3′-Hₜᵣₐₙₛ), 6.32 (d, 1H, 3′-H_{cis}) and 11.9 (br., 1H, COOH).

¹³C-NMR (75.5 MHz, CDCl₃, DEPT): δ=14.0 (2 CH₃), 16.5 (CH₂), 24.7 (CH), 30.8 (C), 35.9 (CH₂), 40.1 (CH₂), 59.9 (C), 61.6 (CH₂), 61.7 (CH₂), 128,2 (CH₂), 141.7 (C), 171.5 (C), 171.8 (C) and, 172.7 (C),

C₁₅H₂₀O₆ (296.32): calculated C 60.80, H 6.80; found C 60.94, H 6.80.

### Stage 3: 10-{2-[3,3-bis(ethoxycarbonyl)bicyclo[3.1.0]hex-1-yl}acryloyloxy}decyl dihydrogen phosphate (3)

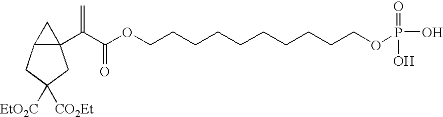

Diethyl azodicarboxylate (2.82 g, 16.2 mmol) was added to a stirred solution of (2) (4.67 g, 15.8 mmol), 10-hydroxydecyl-di-tert.-butyl phosphate (5.80 g, 15.8 mmol) and triphenyl phosphine (4.25 g, 16.2 mmol) in 40 mmol of anhydrous THF under argon and stirring at approximately −78° C. (dry ice/acetone bath), so that the temperature did not rise above −70° C. After 30 minutes' stirring the cold bath was removed, the reaction mixture slowly heated to room temperature and the solvent distilled off under vacuum. The residue was then suspended accompanied by stirring in 10 ml of tert.-butyl methyl ether and diluted by addition of 50 ml of pentane. After stirring in the ice bath for 1 hour the suspension was chromatographically purified over a silica-gel column with a mixture of hexane/ethyl acetate (6:1 to 3:1). 7.95 g (78% yield) of a viscous colorless liquid of 10-{2-[3,3-bis(ethoxycarbonyl)bicyclo[3.1.0]hex-1-yl}acryloyloxy}decyl-di-tert.-butyl phosphate resulted, which was dissolved in a mixture of 20 ml CCl₄ and 2 ml of trifluoroacetic acid to release the corresponding dihydrogen phosphate 3. The mixture was reacted under reduced pressure at 50° C. for approximately 1 hour, the reaction being tracked by means of HPLC and the resultant product being a highly viscous liquid.

¹H-NMR (400 MHz, DMSO-d₆): δ=0.52 (dd, 1H, 6-H_{endo}), 0.74 (ddd, 1H, 6-Hₑₓₒ), 1.21 (t, 3H, CH₃), 1.24 (t, 2×3H, CH₃), 1.26-1.40 (m, 12H, C₃-C₈-decyl) 1.51-1.68 (m, 5H, 1-H+ C_{2.9}-decyl), 2.51-2.62 and 2.71 (m, 3H+1H, both 2.4-H), 3.75-3.85 (m, 2H, CH₂OP), 4.15 (q,2H, OCH₂), 4.17 (q,2H, OCH₂), 5.67 (d, 1H, C=Hₜᵣₐₙₛ), 6.09 (d, 1H, C=H₁ is).

³¹P-NMR (167.5 MHz, DMSO-d₆): 2.74 (s)

### Example 2

### Radical Copolymerization of Monomer 3 with UDMA

To determine the polymerization shrinkage, the urethane dimethacrylate of 2 mol 2-hydroxyethyl methacrylate and 1 mol 2,2,4-trimethyl hexamethylene diisocyanate with 0.3 wt.-% (relative to the total mixture) camphorquinone (photoinitiator) and 0.5 wt.-% 4-(dimethylamino)-benzoic acid ethyl ester (amine accelerator) was added to a mixture of 50 wt.-% monomer (3) and 50 wt.-% UDMA (Ivoclar Vivadent AG)and the whole then irradiated with a dental light source (Spectramat®, Ivoclar Vivadent). A polymerization shrinkage of only 4.4% was calculated from the difference in the determined densities of the monomer mixture and of the formed polymerizate respectively, taking account of the polymerization shrinkage of pure UDMA (ΔV_{P}=6.1%). The polymerization shrinkage of EAEPA was calculated as 7.7% from the results of the polymerization of an analogous mixture of the adhesive monomer 2-[4-(dihydroxyphosphoryl)-2-oxabutyl]-acrylic acid ethyl ester (EAEPA) and UDMA (50:50).

Example 2 shows that compared with (meth)acrylates the vinyl cyclopropanes or cyclopropyl acrylates of Formula (I) are characterized by a clearly smaller polymerization shrinkage.

### Example 3

### Preparation of a Light-Curing Adhesive Based on Monomer 3

To investigate the dentine adhesion to bovine teeth dentine adhesives with the composition given in Table 1 were prepared:

Bovine teeth were embedded in plastic cylinders so that the dentine and the plastic were in one plane. Following 15 seconds' etching with 37% phosphoric acid, thorough rinsing with water was carried out. A layer of adhesive of the above composition was then applied with a microbrush, briefly blown with a fan to remove the solvent and lit for 40 seconds with a halogen lamp (Astralis 7, Ivoclar Vivadent). A composite cylinder of Tetric® Ceram (Ivoclar Vivadent) was polymerized in two layers of 1-2 mm each onto the adhesive layer. The testpieces were then stored in water for 24 hours at 37° C. and the shear strength measured at 26.8 MPa (Adhesive A) and 29.9 MPa (Adhesive B) in accordance with ISO guideline “ISO 2003-ISO TR 11405: Dental Materials Guidance on Testing of Adhesion to Tooth Structure”.

TABLE 1
Composition of the Adhesives (values in wt.-%)

| | | Adhesive B |
|---|---|---|
| Component | Adhesive A | (Comparison) |
| Monomer (3) | 10.9 | — |
| EAEPA¹⁾ | — | 10.9 |
| Glycerine dimethacrylate | 9.9 | 9.9 |
| UDMA²⁾ | 9.9 | 9.9 |
| Bis-GMA³⁾ | 32.7 | 32.7 |
| 2-Hydroxyethyl | 14.9 | 14.9 |
| methacrylate | | |
| Photoinitiator⁴⁾ | 1.7 | 1.7 |
| Ethanol (abs.) | 20.0 | 20.0 |

¹⁾2-[4-(dihydroxyphosphoryl)-2-oxabutyl]acrylic acid ethyl ester
²⁾Addition product of 2-hydroxyethyl methacrylate and 2,2,4-trimethyl hexamethylene diisocyanate
³⁾Addition product of methacrylic acid and bisphenol-A-diglycidyl ether
⁴⁾Mixture of camphorquinone (0.3%), 4-dimethyl-benzoic acid ethyl ester (0.4%) and the acylphosphine oxide Lucerin TPO (1.0%)

### Example 4

### Preparation of a Dental Cement Based on Monomer 3 from Example 1

Corresponding to the following Table 2, a composite fixing cement was prepared based on a methacrylate mixture (Sample A, comparison) and including the ring-opening polymerizable phosphonic acid (3) from Example 1 (Sample B) using an “Exakt” roll mill (Exakt Apparatebau, Norderstedt). Corresponding testpieces of the materials were prepared, which were irradiated twice for 3 minutes with a dental light source (Spectramat®, Ivoclar Vivadent AG) and thus cured. The bending strength, bending E modulus and exothermal time were measured in accordance with ISO standard ISO 4049 (Dentistry—Polymer-based filling, restorative and luting materials).

TABLE 2
Composition of the composite cement (values in wt.-%)

| | Material A | Material B |
|---|---|---|
| Component | (wt.-%) | (wt.-%) |
| Urethane | 31.8 | 31.8 |
| dimethacrylate¹⁾ | | |
| Decanediol | 7.8 | — |
| dimethacrylate | | |
| Monomer (3) | — | 7.8 |
| Aerosil OX-50 | 41.2 | 41.2 |
| (Degussa) | | |
| Ytterbium trifluoride | 18.7 | 18.7 |
| (Rhone-Poulenc) | | |
| Photoinitiator²⁾ | 0.5 | 0.5 |

¹⁾Urethane dimethacrylate of 2 mol 2-hydroxyethyl methacrylate and 1 mol 2,2,4-trimethyl hexamethylene diisocyanate-1,6
²⁾Mixture of camphorquinone (0.24%), p-N,N-dimethyl aminobenzoic acid ethyl ester (0.26%)

Table 3 shows that compared with Material A (based on a purely conventional methacrylate mixture) Material B leads to almost comparable mechanical properties. The slight decrease in mechanical properties after storage in water is attributable to the increase in the hydrophilicity of the composite due to the water-soluble phosphonic acid and is not significant for use in the field of dentistry.

TABLE 3
Cement properties

| Material property | Material A | Material B |
|---|---|---|
| Bending strength (MPa) | 95 | 86 |
| after 24 hours | | |
| Bending strength (MPa) | 101 | 90 |
| after 24 hours WS¹⁾ | | |
| Bending strength (MPa) | 111 | 76 |
| after 7 days WS | | |
| Bending E modulus (GPa) | 4.76 | 4.89 |
| after 24 hours | | |
| Bending E modulus (GPa) | 4.93 | 4.08 |
| after 24 hours WS | | |
| Bending E modulus (GPa) | 5.13 | 4.03 |
| after 7 days WS | | |
| Exothermal time (s) | 13 | 8 |

¹⁾WS = testpieces stored in water

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

What is claimed is:

1. A dental material comprising at least one radically polymerizable monomer according to general formula (I): 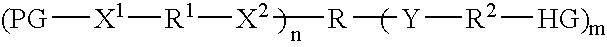
in which
PG=a cyclic, ring-opening polymerizable group;
X¹=is absent, O, S, an ester, amide or urethane group;
X²=is absent, O, S, an ester, amide or urethane group;
Y=is absent, O, S, an ester, amide or urethane group;
R=an organic radical with a valency of (n+m), with 1 to 35 carbon atoms and 0 to 8 heteroatoms, the H atoms of which can be wholly or partially substituted by F atoms;
R¹=is absent or a C₁-C₁₆ alkylene radical which can be interrupted by O atoms;
R²=is absent or a C₁-C₁₆ alkylene radical which can be interrupted by O atoms;
n=1,2,3,4, 5 or 6;
m=1, 2 or 3;
HG=—P═O(OH)₂; —P═O(OH)(OR¹⁴); —O—P═O(OH)₂, —O—P═O(OH)(OR¹⁵) or —SO₂OH with R¹⁴=a C₁-C₁₅ alkyl radical, phenyl or benzyl radical, R¹⁵=a C₁-C₁₅ alkyl radical, phenyl or benzyl radical.

2. The dental material according to claim 1, wherein PG is a group with one of the following formulae: 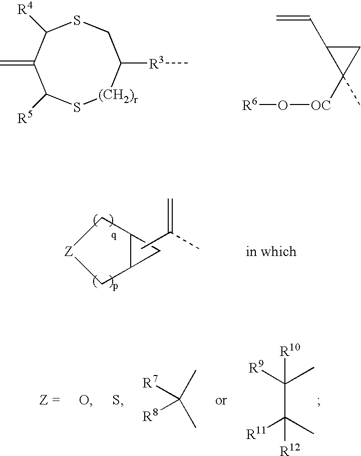
R³=is absent or a C₁-C₁₆ alkylene radical which can be interrupted by O atoms;
R⁴=H or a C₁₀ alkyl radical;
R⁵=H or a C₁-C₁₀ alkyl radical;
R⁶=H, a C₁-C₁₀ alkyl radical, phenyl radical or benzyl radical;
R⁷=H, CN, CO—OR¹³, —CO—R¹³ or R¹³,
R⁸=H, CN, CO—OR³, —CO—R³, or R¹³;
R⁹-R¹²=independently of each other H, —CO—OR¹³, —CONHR¹³, —CO—R¹³, a C₁-C₁₅ alkyl radical which can be interrupted by O, a cycloaliphatic C₄-C₁₂ radical, a bicyclic C₅-C₁₂ radical, a C₆-C₁₄ aryl radical or C₇-C₂₀ alkyl aryl radical;
R¹³=a C₁-C₁₅ alkyl radical which can be interrupted by O, a cycloaliphatic C₄-C₁₂ radical, a bicyclic C₅-C₁₂ radical, a C₆-C₁₄ aryl radical or C₇-C₂₀ alkyl aryl radical, wherein a plurality of R¹³ radicals can be present and can be the same or different;
q=0, 1, 2 or 3;
p=0,1, 2 or 3;
r=0 or 1.

3. The dental material according to claim 2, wherein at least one of R³, R⁴, R⁵, R⁶, R⁷, R⁸, R⁹-R¹², R¹³, q, p or r comprises:
R³=is absent or a C₁-C₁₀ alkylene radical which can be interrupted by O atoms;
R⁴=H or a C₁-C₅ alkyl radical;
R⁵=H or a C₁-C₅ alkyl radical;
R⁶=C₁-C₅ alkyl radical, benzyl or phenyl radical;
R⁷=H, CO—R¹³, —CO—R¹³ or R¹³;
R³=H, CO—OR³, —CO—R³, or R¹³;
R⁹-R¹²=independently of each other H, —CO—R¹³, —CO—R¹³, a C₁-C₁₅ alkyl radical which can be interrupted by O, a cycloaliphatic C₄-C₆ radical, a bicyclic C₅-C₁₂ radical, a phenyl or benzyl radical;
R¹³=a C₁-C₁₀ alkyl radical which can be interrupted by O, a cycloaliphatic C₄-C₆ radical, a phenyl or benzyl radical, wherein a plurality of R¹³ radicals can be present and can be the same or different;
q=0, 1 or 2;
p=0, 1 or 3;
r=0 or 1.

4. The dental material according to claim 2, wherein PG is a group of the formula

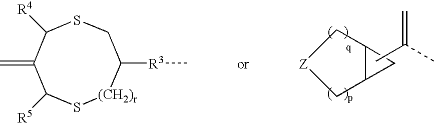

5. The dental material according to wherein at least one of X¹, X², Y, R, R¹, R², n, m, or HG comprises:
X¹=absent, O, an ester, amide or urethane group;
X²=absent, O, an ester, amide or urethane group;
Y=is absent, O, an ester, amide or urethane group;
R=an organic radical with a valency of (n+m) with 1 to 20 carbon atoms and 0 to 8 heteroatoms, the H atoms of which can be wholly or partially substituted by F atoms;
R¹=is dispensed with or a C₁-C₁₂ alkylene radical which can be interrupted by O atoms;
R²=is dispensed with or a C₁-C₁₂ alkylene radical which can be interrupted by O atoms;
n=1, 2 or 3;
m=1, 2 or 3;
HG=—P═O(OH)₂; —O—P═O(OH)₂ or —SO₂OH.

6. The dental material according to claim 5, in which at least one of the variables has one of X¹, X², Y, R, R¹, R², n, m, or HG comprises:
X¹=is absent or an ester group;
X²=is absent;
Y=is absent;
R=an aliphatic organic radical with 2 to 12 carbon atoms, the H atoms of which can be wholly or partially substituted by F atoms, or phenylene;
R¹=is absent;
R²=is absent, methylene or ethylene;
n=1 or 2;
m=1;
HG=—P═O(OH)₂; —O—P═O(OH)₂ or —SO₂OH.

7. The dental material according to claim 1, further comprising an initiator for radical polymerization.

8. The dental material according to claim 1, further comprising at least one further radically polymerizable monomer.

9. The dental material according to claim 8, comprising at least one radically polymerizable monomer with two or more radically polymerizable groups.

10. The dental material according to claim 9, comprising at least one monomer which is selected from bi- or multifunctional acrylates and methacrylates, bisphenol-A-di(meth)acrylate, bis-GMA (an addition product of methacrylic acid and bisphenol-A-diglycidyl ether), UDMA (an addition product of 2-hydroxyethyl methacrylate and 2,2,4-trimethyl hexamethylene diisocyanate), di-, tri- or tetraethylene glycol di(meth)acrylate, trimethylolpropane tri(meth)acrylate, pentaerythritol tetra(meth)acrylate, butanediol di(meth)acrylate, 1,10-decanediol di(meth)acrylate or 1,12-dodecanediol di(meth)acrylate.

11. The dental material according to claim 8, comprising at least one radically ring-opening polymerizable monomer.

12. The dental material according to claim 11, comprising at least one monomer which is selected from mono- and multifunctional vinyl cyclopropanes, bicyclic cyclopropane derivatives or cyclic allyl sulphides.

13. The dental material according to one of claim 8, further comprising at least one additional radically polymerizable, acid group-containing monomer.

14. The dental material according to claim 1, further comprising at least one filler.

15. The dental material according to claim 1, further comprising at least one additive, which is selected from stabilizers, UV-absorbers, dyes, pigments, solvents and lubricants.

16. The dental material according to claim 1, comprising:
(a) 0.5 to 30 wt.-% acid ring-opening polymerizable monomer according to Formula (I),
(b) 0.01 to 5 wt.-% initiator,
(c) 5 to 90 wt.-% further radically polymerizable monomer,
(d) 0 to 85 wt.-% filler,
(e) 0 to 50 wt.-% solvent.

17. The dental material according to claim 16, further comprising:
(f) 0.01-5 wt % additive.

18. The dental material according to claim 16, wherein (c) comprises 5-90 wt.-% additional ring-opening polymerizable monomer and 0-50 wt.-% multi-functional (meth)acrylate.

19. The dental material of claim 1, wherein the dental material comprises a composite, cement, adhesive or coating material.

20. A process for the preparation of a shaped body, comprising shaping a dental material according to claim 1 to produce a body with the desired shape, and then partially or completely curing the material.
